(19) United States
(12) Patent Application Publication
(10) Pub. No.: US 2025/0205111 A1
(43) Pub. Date: Jun. 26, 2025

(54) HUMAN BODY STIMULATION SYSTEM PROVIDING VIBRATIONS USING ACOUSTIC PRESSURE AND BONE CONDUCTION SOUND USING PHOTOACOUSTIC SOUND

(71) Applicant: ARIBIO CO., LTD., Seongnam-si (KR)

(72) Inventors: Jaijun CHOUNG, Seongnam-si (KR); Soohyun SUNG, Seongnam-si (KR); Jae Young HA, Seongnam-si (KR); Jaeyeong CHOE, Seongnam-si (KR); Changho SHIN, Seongnam-si (KR)

(73) Assignee: ARIBIO CO., LTD., Seongnam-si, GY (KR)

(21) Appl. No.: 18/833,373

(22) PCT Filed: Oct. 6, 2022
(86) PCT No.: PCT/KR22/08196

§ 371 Date: Feb. 12, 2025

(30) Foreign Application Priority Data
Jan. 27, 2022 (KR) 10-2022-0011875

(51) Int. Cl. A61H 23/02

(52) U.S. Cl. CPC A61H 23/0236; A61H 2201/5005

(57) ABSTRACT

The present invention relates to a human body stimulation system providing vibrations using acoustic pressure and bone conduction sound using photoacoustic sound. More specifically, the present invention relates to a human body stimulation system providing vibrations using acoustic pressure and bone conduction sound using photoacoustic sound, wherein the system comprises: a vibration device configured to provide vibrations using acoustic pressure to the human body; and a transducer providing bone conduction sound using photoacoustic sound, and thus can provide vibrations (tactile sensations) and bone conduction sound (auditory sensations) to the human body (especially the brain). According to the present invention, bone conduction sound can be provided at the same time as human body stimulation for vibrations.

### TECHNICAL FIELD

The present invention relates to a human body stimulation system providing vibrations using acoustic pressure and bone conduction sound using photoacoustic sound.

More specifically, the present invention relates to a human body stimulation system providing vibrations using acoustic pressure and bone conduction sound using photoacoustic sound, wherein the system comprises: a vibration device configured to provide vibrations using acoustic pressure to the human body; and a transducer providing bone conduction sound using photoacoustic sound, and thus can provide vibrations (tactile sensations) and bone conduction sound (auditory sensations) to the human body (especially the brain).

According to the present invention, bone conduction sound can be provided simultaneously with human body stimulation for vibrations.

### BACKGROUND ART

The human body naturally ages over time, resulting in natural pain as well as activity restrictions due to partial degenerative damage. Additionally, activity restrictions due to industrial and technological developments, traffic accidents, industrial accidents, sports injuries, and simple accidents in activity, as well as various complications from stress, lack of exercise, and obesity, are causing various symptoms such as brain damage, myocardial infarction, arteriosclerosis, and arthritis.

To treat the pain, damage, obesity; etc. caused by these natural human phenomena or sociocultural issues, various stimulation devices, etc. along with pharmaceuticals and health functional foods are being developed and utilized. Such stimulation devices include massage devices.

Generally, a massage device is a device that massages by stimulating the skin or scalp while tapping or rubbing the skin or scalp to achieve smooth blood circulation, promote fat decomposition, and discharge waste. Such massage devices generate vibrations or electrical stimulation using electrical signals and apply them to the skin or scalp. For example, massage devices include low-frequency massage devices that massage by passing low-frequency current through the human body via electrodes attached to the skin surface, ultrasonic massage devices that deliver ultrasonic vibrations to the human body by placing an ultrasonic irradiation probe in contact with the skin surface, and massage devices that employ ultra-low frequencies or far-infrared rays, and the like.

However, through many technologies are being applied and utilized, as for human body vibration stimulation technologies currently being utilized, such as linear stimulation using simple rotary vibration motors and solenoids, pressurization methods using air pressure, stimulators that induce muscle contraction by inputting low-frequency current, and methods that contract muscles utilizing magnetic fields, etc., they merely apply pressure or stimulation to the human body and each technology has its own limitations.

For example, in the case of vibrators using motors, although the vibration frequency can be adjusted, its incorrect use due to the shortcoming not to adjust the amplitude or intensity results in human body damage, and they have the structure and properties which the vibration frequency cannot also be delivered rhythmically.

Recently, stimulation methods utilizing the principles of speakers have been provided to improve this, but they do not implement enough intensity to provide smooth tactile sensation and merely perform the function of a subwoofer of a speaker.

Additionally; technologies utilizing low-frequency current, technologies utilizing ultrasound, technologies utilizing high-frequency, etc., have been disclosed and applied, but, in the case of low-frequency technologies, there is a lot of inconvenience for users, and in the case of ultrasound technologies, it is difficult to immediately adapt to the user's sensations and effects, and there are fatal difficulties in use because the affected area is exposed and a medium is needed to transmit low-frequency or ultrasound.

In the case of the high-frequency technologies, they are intended for deep heat rather than for stimulating device, and thus, have an inherent risk factor for the user due to the characteristics of high frequency as well as the user's anxiety. In the case of high-frequency technologies, they require the exposure of affected areas and a medium for transmission in use, as well as, they utilize conductive plates for transmission of both poles of electricity, so they are not only dangerous but also cause many inconvenience in use.

Low-frequency therapeutic devices had problems that they continuously and repeatedly apply low-frequency current in the form of low-frequency pulses to the skin through electrodes, generating a sensation similar to an electric shock, which makes the treatment unpleasant and halves the therapeutic effects. Additionally, the low-frequency therapeutic devices had problems that the affected areas must be exposed in order to attach the electrodes to the skin, which makes the female users avoid these devices and the like.

Furthermore, the ultrasound treatment and beauty devices had various problems, including that: the ultrasound vibrations propagate when the skin contact surface of the ultrasound irradiation probe touches the skin, but if the probe is placed incorrectly on the skin, the ultrasound vibrations do not propagate, resulting in unsatisfactory effects, and regardless of whether the probe makes good contact with the skin, since the ultrasound output set by the user is irradiated, the vibration propagating part of the probe generates heat by the vibration in the case of non-contact, which increases the temperature of this part, causing discomfort to the user, a risk of burns if used for a long time, and the like.

Additionally, various skin care modes can be implemented by using a vibrator that vibrates vertically by a magnetic coil method, and various technologies have been disclosed for galvanic massage and iontophoresis massage using said vibrator.

However, these conventional technologies have problem that they apply a method of converting the rotational force of a vibration motor into linear or cam motion to stimulate the skin, and thus, the process of transmitting the vibration motor's power causes significant noise, which gives displeasure for users of beauty devices In addition, since the principle is to cause vibration by eccentricity; the force dispersed in the horizontal direction—that is, in the direction parallel to the skin surface—is large and the force acting perpendicular to the skin surface is small, they also have a problem not to effectively perform skin massage.

Additionally, devices that generate sound waves by applying the principle of speakers and devices that can generate sound sources have been developed, but, due to problems such as structural characteristics of the magnetic circuit and the position of the leaf spring and coil, etc., they have problems in that the frequency generation range is small, and the intensity is also very weak. In addition, because such devices must be configured with a guide that uses bearings to maintain sound wave vibration in a vertical form and a coil spring to maintain elasticity, there are limitations to the degree to which they can be miniaturized.

These conventional technologies have very limited usage modes and functions, making it difficult for them to effectively manage the human body.

### DETAILED DESCRIPTION OF INVENTION

### Technical Problem

The object of the present invention relates to a human body stimulation system providing vibrations using acoustic pressure and bone conduction sound using photoacoustic sound, wherein the system comprises: a vibration device configured to provide vibrations using acoustic pressure to the human body; and a transducer providing bone conduction sound using photoacoustic sound, and thus can provide vibrations (tactile sensations) and bone conduction sound (auditory sensations) to the human body (especially the brain).

### Technical Solution

The human body stimulation system providing vibrations using acoustic pressure and bone conduction sound using photoacoustic sound according to the present invention to achieve the above purposes comprises: a human body stimulation device (200) providing vibrations using acoustic pressure to the human body through a vibration device (100); and a bone conduction sound generating device (300) providing bone conduction sound using photoacoustic sound through a transducer (400): wherein the human body stimulation system is characterized in that it can provide vibrations and bone conduction sound simultaneously to the human body, thereby enhancing the effects of human body stimulation.

### Effect of the Invention

As described above, according to the human body stimulation system providing vibrations using acoustic pressure and bone conduction sound using photoacoustic sound according to the present invention, since it can provide a vibration using acoustic pressure and bone conduction sound using photoacoustic sound, and thus can improve the efficiency of human body stimulation and consequently enhance the additional effects on the human body, wherein the system comprises a vibration device configured to provide vibrations using acoustic pressure to the human body; and a transducer providing bone conduction sound using photoacoustic sound, and thus can provide vibrations (tactile sensations) and bone conduction sound (auditory sensations) to the human body (especially the brain).

### BRIEF DESCRIPTION OF FIGURES

FIG. 1 is an exploded perspective view of the vibration device of the human body stimulation system providing vibrations using acoustic pressure and bone conduction sound using photoacoustic sound according to the present invention.

FIG. 2 shows the coupled state of the vibration device of FIG. 1.

FIG. 2a shows another embodiment of the vibration device.

FIG. 2b is an enlarged view of the elastic body of FIG. 2a.

FIGS. 3a and 3b show the coupled state according to another embodiment of the connecting member of FIG. 1.

FIG. 4 shows the configuration of the human body stimulation device equipped with the vibration device of FIG. 1.

FIG. 5 shows a block diagram showing the configuration of the human body stimulation device of FIG. 4.

FIG. 6 shows a bone conduction sound generating device, which is the remaining component of the human body stimulation system providing vibrations using acoustic pressure and bone conduction sound using photoacoustic sound according to the present invention.

### MODES FOR CARRYING OUT THE INVENTION

The terms or words used in the present specification and the claims should not be interpreted as being limited to their usual or dictionary meanings, and must be interpreted as meaning and concepts that conform to the technical idea of the present invention based on the principle that the inventor(s) may appropriately define the concept of the terms in order to explain their own invention in the best way.

Therefore, the embodiments described in the present specification, and the configurations shown in the drawings are merely the most preferred embodiments of the present invention and do not represent all the technical ideas of the present invention, so it should be understood that there may be various equivalents and modifications that can replace them at the time of filing the present application.

Hereinafter, prior to describing the invention with reference to the drawings, it is noted that unnecessary details, i.e., known configurations that can easily be added by those skilled in the art, have not been shown or specifically described, so as to reveal the gist of the present invention.

The present invention relates to a human body stimulation system providing vibrations using acoustic pressure and bone conduction sound using photoacoustic sound.

More specifically, the present invention relates to a human body stimulation system providing vibrations using acoustic pressure and bone conduction sound using photoacoustic sound, wherein the system comprises: a vibration device configured to provide vibrations using acoustic pressure to the human body; and a transducer providing bone conduction sound using photoacoustic sound, and thus can provide vibrations (tactile sensations) and bone conduction sound (auditory sensations) to the human body (especially the brain).

According to the present invention, bone conduction sound can be provided simultaneously with human body stimulation for vibrations.

As shown in the accompanying drawings, the present invention is configured to comprise: a vibration device (100): a human body stimulation device (200); and a bone conduction sound generating device (300).

### Vibration Device

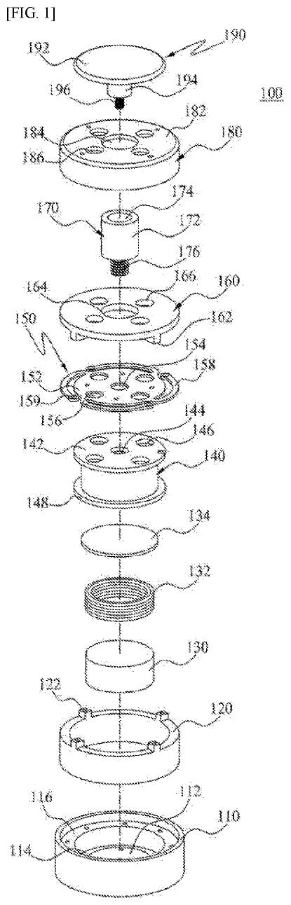

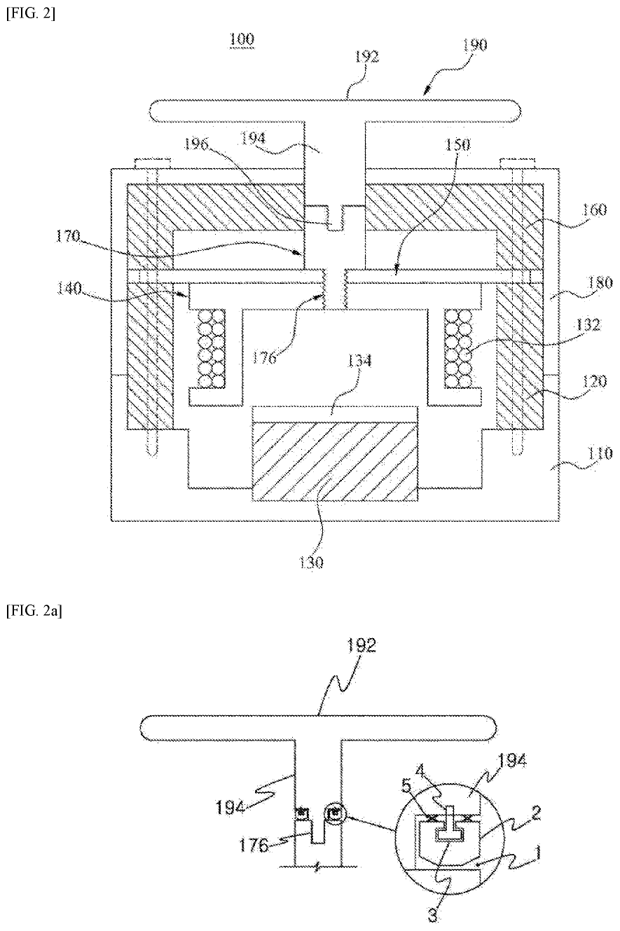

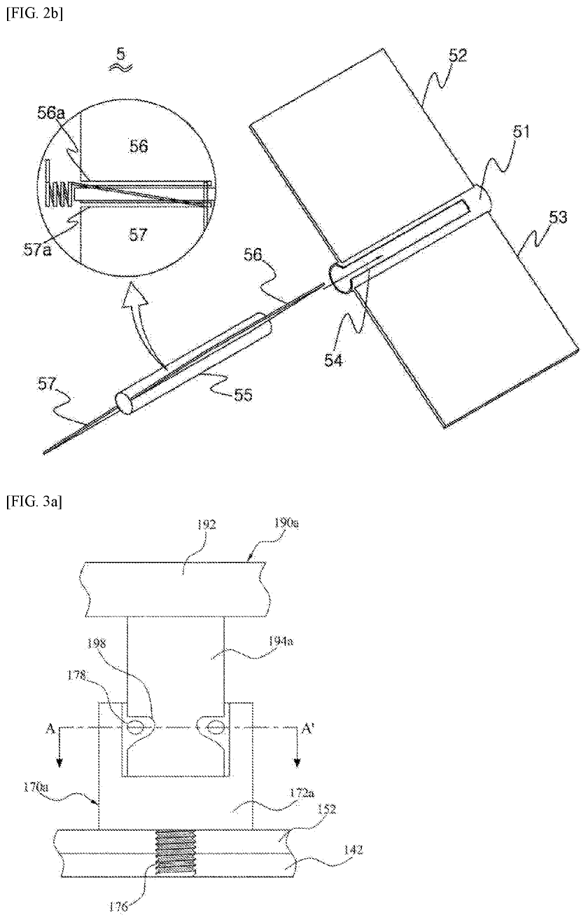

Referring to FIGS. 1 and 2, the vibration device (100) of the present invention comprises: an upper and lower body (110, 180), an upper and lower bracket (120, 160), a magnetic body (130), a voice coil (132), an upper plate (134), a bobbin (140), a congee damper (150), and a connecting member (170). The vibration device (100) may also be equipped with a waterproof member or a buffer member, although such is not shown in the drawings.

The configuration of the vibration device is described in detail for this embodiment using a connecting member (170) for transmitting vibrations and a vibration probe (190) coupled to the connecting member (170) for massaging and stimulating the human body, so as to transmit the vibrations generated from the vibration device (100) to the outside and be able to massage and stimulate the skin or scalp of the human body,

That is, the vibration probe (190) is detachably equipped to the vibration device (100).

The vibration probe (190) can have various shapes and sizes to suit the various uses of the human body stimulation device (200 of FIG. 4) described later.

The vibration probe (190) of this embodiment comprises: a plate (192) to which a massage or stimulation head (not shown) is attached and detached, a shaft (194) coupled to the center of the lower surface of the plate (192), and a coupling part (196) provided at the lower end of the shaft (194) to be mutually coupled with the connecting member (170). The coupling part (196) is provided in the form of a bolt that is screw coupled with the connecting member (170).

Meanwhile, the above-described vibration probe (190) has a concave groove (1) formed upward on one side of the lower surface where the bolt (176) of the shaft (194) is not formed, and on the groove (1), the vibrating body (2) is coupled to the groove (1) by a connector (4).

At this time, the connector (4) has a two-step shape of “L”, and a part of the connector (4) is inserted into and secured in place in the insertion groove (3) formed in the vibrating body (2).

The size of the insertion groove (3) is made larger than the size of the part of the connector (4) inserted into the insertion groove.

This is shown in FIG. 2a.

FIG. 2a shows another embodiment of the vibration device.

Additionally, the vibrating body (2) is smaller than the groove (1), allowing the vibrating body to pivot around the connector (4) within the groove (1).

At this time, a elastic body (5) is provided between one surface of the groove (1) and the upper surface of the vibrating body (2), and the above-described elastic body (5) can be referred to in FIG. 2b of the attached drawings.

FIG. 2b is an enlarged view of the elastic body of FIG. 2a.

The elastic body (5) according to FIG. 2b of the attached drawings has a cylindrical shape with a hollow inside and symmetrically extending a first wing (52) and a second wing (53) on both sides, and comprises: a first shaft (51) having two guide grooves (54) formed along the longitudinal direction on one side and that is open at one end:
a second shaft (55) having a cylindrical shape and symmetrically extending third wing (56) and fourth wing (57) on both sides;
wherein the third wing (56) and fourth wing (57) each include an insertion groove (56a, 57a) formed adjacent to the second shaft (55) and having a certain length.

That is, the second shaft (55) is inserted into the hollow of the first shaft (51) as the third wing (56) and fourth wing (57) are inserted and guided into each of the guide grooves (54) of the first shaft (51).

Additionally, a torsion spring is inserted through the insertion groove (56a, 57a) as shown in FIG. 2b, with one protruding end of the torsion spring being secured in place in close contact with one surface of the third wing (56), and the other protruding end in the other direction being secured in place in close contact with one surface of the second wing (53).

Accordingly, the said elastic body (50) can be operated to fold to the extent that the third wing (56) and fourth wing (57) can move from the guide grooves (54), while having an “X” shape due to the elastic force of the torsion spring.

With this configuration, the shaft (194) of the vibration probe (190) according to the present invention has the effects of increasing the intensity of vibration mode by the vibrating body (2), and also reducing the impact due to the vibration applied to the probe itself even when the intensity of vibration increases by the elastic body (5).

At this time, the vibrating body (2) includes an inclined surface slanted in a predetermined direction on the lower surface as shown in FIG. 2a of the attached drawings, and thus, allowing the vibrating body (2) to pivot without being affected by the upper surface of the connecting member (170) corresponding to the lower surface of the groove (1). The embodiment of this lower surface may have a wedge or cone shape different from the attached drawings.

Specifically; the lower body (110) is equipped with a cylindrical shape having an open top part, forming a space where the magnetic body (130) is installed inside. The magnetic body (130) is fixedly installed on the bottom surface of the inner space of the lower body (110). Additionally, the lower bracket (120) is insert installed outside the magnetic body (130) in the inner space of the lower body (110). To this end, the lower body (110) is equipped with a securing groove (112) formed on the bottom surface where the magnetic body (130) is fixedly installed, a ring-shaped separation groove (114) equipped to be spaced a certain distance from the outer circumferential surface of the magnetic body (130) secured in the securing groove (112), and a ring-shaped mounting groove (116) where the lower bracket (120) is mounted to be spaced a certain distance from the magnetic body (130). A separation groove (114) is equipped to form the magnetic path created by the magnetic body (130) and the voice coil (132).

The upper body (180) is equipped with a cylindrical shape having an open bottom, covering the open top of the lower body (110). The upper body (180) is coupled to the lower body (110), forming a space to accommodate components (120-160) inside. The upper surface (182) of the upper body (180) is formed with an insertion hole (184) through which the shaft (194) of the connecting member (170) and the vibration probe (190) are inserted to pass through the center, and a plurality of heat dissipation holes (186) provided outside the insertion hole (184) to release heat generated during the vibration of the vibration device (100). Additionally, the upper surface (182) of the upper body (180) may further be equipped with, for example, a waterproof member (not shown), such as silicone, etc., for waterproofing the insertion hole (184) where the vibration probe (190) is inserted. The upper body (180) and lower body (110) are made of aluminum to enhance the heat dissipation effect.

The lower bracket (120) is equipped with a cylindrical shape with an open top and bottom. The lower bracket (120) is installed in the mounting groove (116) of the lower body (110), and its upper surface is coupled with the congee damper (170). To this end, the lower bracket (120) is equipped with a plurality of coupling protrusions (122) on its upper surface. Inside the lower bracket (120), a bobbin (140) with a voice coil (132) mounted on it is installed. A part of the lower bracket (120) protrudes to the upper part of the lower body (110). The coupling protrusions (122) of the lower bracket (120) may be further secured by using a silicone washer, etc., for ensuring durability and maintaining the vibration force upon coupling with the damper (158) of the congee damper (150). A silicone washer can be selectively used to adjust the height of the congee damper (150) according to frequency properties, thereby performing the function for maintaining efficient amplitude.

The upper bracket (160) is equipped with a plate shape to be accommodated inside the upper body (180), and its edge is coupled with the upper part of the lower bracket (120). The lower surface of the edge of the upper bracket (160) is equipped with a plurality of coupling protrusions (162) to couple the congee damper (150) and the lower bracket (120).

The upper surface of the upper bracket (160) is equipped with a generally circular shape and faces the lower bracket (120). The upper surface of the upper bracket (160) is formed with an insertion hole (164) through which the connecting member (170) is inserted to pass through the center, and a plurality of heat dissipation holes (166) equipped outside the insertion hole (164) to release heat generated during the vibration of the vibration device (100). These insertion holes (184, 164) of the upper body (180) and the upper bracket (160) secure the connecting member (170) and the vibration probe (190) to the center of the vibration device (100). Additionally, a buffer member (not shown) such as a plate spring, etc., may be further equipped between the upper surface of the upper bracket (160) and the upper body (180) to prevent unnecessary vibration transmission.

The magnetic body (130) is fixedly installed in the securing groove (112) of the lower body (110) and interacts with the voice coil (132) to generate a magnetic field. The magnetic body (130) is equipped as a permanent magnet of a ferromagnetic material, such as a neodymium magnet, etc. An upper plate (134) is installed on the upper surface of the magnetic body (130).

The voice coil (132) is installed on the outer circumferential surface of the bobbin (140) above the magnetic body (130). The voice coil (132) is guided to be stably installed by the bobbin (140). The voice coil (132) receives power and interacts with the magnetic body (130) to generate a magnetic field. The magnetic body (130) and the voice coil (132) are installed inside the lower bracket (120).

The upper plate (134) has a shape that is generally similar to the upper surface of the magnetic body (130), is equipped on the upper part of the magnetic body (130), and is installed adjacent to the lower surface of the bobbin (140). The upper plate (134) guides the magnetic force of the magnetic body (130) to be concentrated on the voice coil (132) to prevent the loss of the magnetic field generated by the magnetic body (130). The upper plate (134) may be applied with a magnetic fluid (not shown) on its outer circumference to form a magnetic field.

The bobbin (140) is provided as a non-magnetic material, such as aluminum, etc. The bobbin (140) is installed inside the lower bracket (120). The bobbin (140) guides the voice coil (132) to be stably installed on its outer side, preventing the voice coil (132) from coming off. The bobbin (140) is coupled to the connecting member (170) at the center of its upper surface. To this end, the bobbin (140) is equipped with a cylindrical shape with open upper and lower sides, the upper surface (142) being larger than the radius of the side, and the lower side extending outward to have a lower surface (148) facing the upper surface (142). The voice coil (132) is installed on the side of the bobbin (140). At this time, the voice coil (132) is guided by the upper surface (142) and the lower surface (148) of the bobbin (140).

Further, the upper surface (142) of the bobbin (140) is formed with a coupling hole (144) at the center to couple with the lower end of the connecting member (170), and a plurality of heat dissipation holes (146) equipped outside the coupling hole (144) to release heat generated when the vibration device (100) vibrates. These heat dissipation holes (146) function to reduce noise upon occurring vibration along with the heat dissipation effect. Additionally, the bobbin (140) releases the heat generated from the voice coil (132).

In the bobbin (140), the magnetic body (130) is secured in place in the securing groove (112) of the lower body (110), and is positioned on the inner circumference of the lower surface (148) of the bobbin (140), creating an efficient magnetic field. Thereby, when the voice coil (132) wound around the bobbin (140) is magnetized, it generates mutual attraction and repulsion forces, producing stable vibration force. Additionally, with respect to the bobbin (140), since the vibration probe (190) is coupled through the connecting member (170), it serves as that even if physical eccentricity occurs when the human body is stimulated by the vibration probe (190), the strong magnetic path created by the coupling of the magnetic body (130) and the upper plate (134) corrects the eccentricity in the bobbin (140).

The congee damper (150) is installed on the upper surface (142) of the bobbin (140), generating vertical vibrations using the magnetic field created by the interaction between the magnetic body (130) and the voice coil (132). That is, the congee damper (150) generates vibrations by acting like a speaker on the sound of the sound source, wherein the vibrations from the sound source cause the air to oscillate.

The congee damper (150) is coupled with the upper and lower brackets (120, 160) at its edges. To this end, the congee damper (150) includes a congee plate (152) and a plurality of dampers (158). The congee plate (152) is formed with a coupling hole (154) at the center to couple with the lower end of the connecting member (170), and a plurality of heat dissipation holes (156) are formed outside the coupling hole (154). Each of dampers (158) is equipped in a radially elongated curved strip shape on the congee plate (152) to maximize the vibration force of the congee damper (150), with a coupling hole (159) for screw coupling formed at the end. The dampers (158) are screw coupled and secured in place between the coupling protrusions (162) of the upper bracket (160) and the coupling protrusions (122) of the lower bracket (120) by the coupling holes (159).

Additionally, to ensure durability; the congee damper (150) is supported by elastic members such as silicone washers on the upper and lower parts of the coupling holes (159) of the dampers (158), preventing vibration attenuation and generating smooth sound when the vibration occurs.

Therefore, the congee damper (150) generates vibrations in response to changes in the acoustic pressure of the sound source to be supplied from the outside. The congee damper (150) is coupled with the connecting member (170) at the center, transmitting vibrations to external components such as the vibration probe (190), etc., through the connecting member (170). Because the central part of the congee damper (150) has the largest vibration amplitude, coupling the bolt (176) of the connecting member (170) with the coupling hole (154) of the congee damper (150) can improve vibration transmission efficiency: In this embodiment, with respect to the vibration device (100), the connecting member (170) is coupled at the center of the upper surface (142) of the congee damper (150) and the bobbin (140) to enhance the coupling force with the connecting member (170).

Also, the connecting member (170) directly receives and then transmits the vibrations generated from the congee damper (150) to the outside. In this embodiment, the connecting member (170) is coupled with the shaft (194) of the vibration probe (190). In other words, the connecting member (170) is equipped in a shaft shape, with the upper part coupled to the shaft (194) of the vibration probe (190), and the lower part coupled to the upper surface (142) of the congee damper (150) and the bobbin (140).

To this end, the connecting member (170) is equipped with a shaft-shaped body (172), a coupling groove (174) at the upper part of the body (172) for coupling with the shaft (194), and a coupling bolt (176) at the lower part of the body (172) for coupling with the coupling hole (154) of the congee damper (150) and the coupling hole (144) of the bobbin (140). In this embodiment, the inside of the coupling hole (174) has a structure where the coupling part (196) of the shaft (194) is screw coupled.

Therefore, in the vibration device (100) of the present invention, the shaft (194) of the vibration probe (190) is inserted through the center of the upper body (180) and coupled with the connecting member (170), and the connecting member (170) is inserted through the upper bracket (160) and screw coupled to the center of the congee damper (150) and the bobbin (140). Thus, in to the vibration device (100), when the congee damper (150) generates vertical vibrations due to acoustic pressure, the vibrations are transmitted to the vibration probe (190) through the connecting member (170) coupled to the congee damper (170).

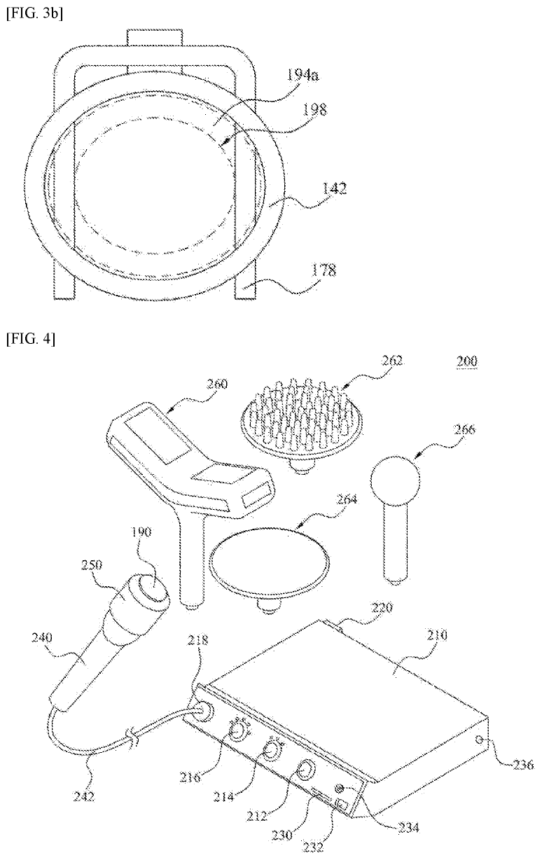

Another embodiment of the connecting member (170) is shown in FIG. 3.

Referring to FIGS. 3a and 3b, in this embodiment, the vibration probe (190a) is formed with a securing groove (198) at a specific position along the outer circumferential surface of the shaft (194a). The securing groove (198) is formed, for example, on the outer circumferential surface of the part where the shaft (194a) of the vibration probe (190a) is inserted into the coupling groove (174) of the connecting member (170a). The securing groove (125) is formed with a locking step at the upper part and a guide part formed at the lower part.

Also, a elastic securing pin (178) inserted into the securing groove (198) is fixedly mounted on the connecting member (170a). The elastic securing pin (178) is fixedly coupled on the outer side of the connecting member (170a), with a part exposed inside the coupling groove (174) of the connecting member (170a), and the exposed part is seated in or separated from the securing groove (198) of the shaft (194a).

This connecting member (170a) guides the elastic securing pin (178) to be seated in the securing groove (198) by the guide part of the securing groove (198) when the shaft (194a) of the vibration probe (190a) is pressed downward and inserted into the coupling groove (174), and the elastic securing pin (178) is fixedly mounted in by the locking step at the same time. Additionally, with respect to the connecting member (170a), when the shaft (194a) is pressed upward and separated from the coupling groove (174), the elastic securing pin (178) is easily detached from the securing groove (178) by the guide part of the securing groove (198).

In this embodiment, the vibration probe (190a) can be more easily coupled with and separated from the connecting member (170) compared to the screw-coupled structure of FIGS. 1 and 2, and it can prevent damage to the coupling part (196) of the vibration probe (190) that may occur due to several times of coupling and separation of the vibration probe (190a) with the vibration device (100).

Therefore, the vibration probe (190, 190a) of the present invention is easy to assemble during manufacturing as it uses a connecting member (170, 170a) that is coupled using screw coupling or a securing groove (198) and a elastic securing pin (178).

As described above, the vibration device (100) of the present invention directly receives vibrations from the center of the congee damper (150) by coupling the connecting member (170, 170a) and the shaft (194, 194a) of the vibration probe (190, 190a) to the center of the congee damper (150), which generates vibrations in response to changes in the acoustic pressure of the sound source. Additionally, the vibration device (100) of the present invention improves the coupling force with the connecting member by coupling the connecting member (170) and the shaft (194, 194a) of the vibration probe (190, 190a) to the center of the upper surface (142) of the bobbin (140) along with the congee damper (150), thereby being able to enhance vibration transmission efficiency.

Furthermore, the vibration device (100) of the present invention can improve vibration generation efficiency as it is configured with a congee plate (152) that functions to generate sound waves on the congee damper (150) in the shape of a plate springs and a damper (158) that functions to transmit vibration force and act as a spring, doing so to generate vibrations stably.

Also, although the vibration device (100) of the present invention is described as having a structure with upper and lower bodies (110, 180) and upper and lower brackets (120, 160), it can be implemented without the upper body (180) and upper bracket (160) to simplify the structure and improve vibration generation efficiency and heat dissipation effect. This is because the connecting member (170) is coupled to the upper surface (142) of the congee damper (150) and the bobbin (140), ensuring a firm coupling with the vibration probe (190).

### Human Body Stimulation Device

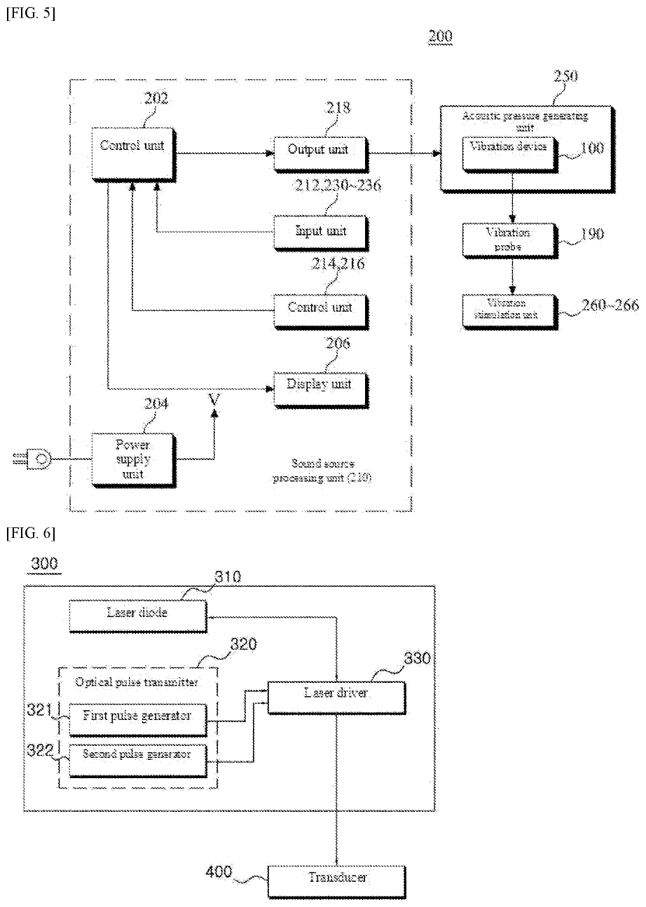

Referring to FIGS. 4 and 5, the human body stimulation device (200) of the present invention uses the vibration device (100) of FIG. 1 or FIG. 3 to receive vibrations generated in response to changes in the acoustic pressure of the sound source and provide massage or stimulation to the human body.

Specifically, the human body stimulation device (200) comprises: a sound source processing unit (210), an acoustic pressure generating unit (250) equipping with the vibration device (100), a vibration probe (190) that transmits the vibrations generated by the acoustic pressure generating unit (250) to the outside, and various types of vibration stimulation units (260-266) equipped for use in massage and stimulation.

The sound source processing unit (210) is equipped inside with devices (not shown) for sound source playback, such as codecs, amplifiers, and speakers, etc., and processes the sound source so that the vibration device (100) generates vibrations using the sound source. Additionally, the sound source processing unit (210) outputs sound wave signals corresponding to the sound source to the acoustic pressure generating unit (250).

The sound source processing unit (210) of this embodiment comprises: a control unit (202), an input unit (212, 230-236), an output unit (218), an adjustment unit (214, 216), a display unit (206), and a power supply unit (204).

The input unit (212, 230˜236) comprises: a power switch (212) for supplying and cutting off power, and various interface devices for inputting sound sources to the sound source processing unit (210), such as a memory card input unit (230), a USB input unit (232), an AUX input unit (234), a wireless communication input unit (236), and the like.

The memory card input unit (230) allows various portable storage media on which sound sources are stored, such as SD cards, CF cards, memory sticks, MMC cards, smart media, etc., to be inserted to input sound sources to the sound source processing unit (210). A USB input unit (232) connects to an external USB device, such as an MP3 player, smartphone, personal digital assistant (PDAs), portable multimedia player (PMP), USB memory, and the like, and inputs sound sources. An AUX input unit (234) inputs sound sources using wired communication. And a wireless communication input unit (236) receives sound sources from external or wireless internet using, for example, a Wi-Fi network, Bluetooth wireless network, and the like. Therefore, the sound source processing unit (210) accepts sound sources desired or preferred by the user by means of various interface devices, processes the sound sources, and outputs sound wave signals.

The output unit (218) outputs the sound wave signals generated by processing the sound sources to the acoustic pressure generating unit (250). The output unit (218) is connected to the acoustic pressure generating unit (250) through a connector and a connection cable (242).

The control unit (214, 216) comprises: an intensity control unit (214) and a frequency control unit (216), which are equipped in the form of buttons or dial knobs. The intensity control unit (214) adjusts the intensity of the acoustic pressure generated from the input internal or external sound source. The frequency control unit (216) adjusts the key, i.e., the frequency; of the built-in sound source.

The display unit (206) is equipped with, for example, a light-emitting diode or a liquid crystal display panel of the sound source processing unit (210), and displays the operating status of the sound source processing unit (210), such as power on/off status, sound source playback status, control status, and the like.

The power supply unit (204) receives AC power through the power input unit (220) and supplies power (V) to the sound source processing unit (210).

Also, the control unit (202) controls and processes all the operations of the sound source processing unit (210). The control unit (202) controls the power supply from the power supply unit (204) when the power switch (212) is pressed. The control unit (202) processes the input of the sound source from the input unit (230-236) and processes the output of the sound wave signal to the output unit (218). The control unit (202) processes the playback of the sound source in response to the adjustment of the acoustic pressure intensity or frequency by the intensity control unit (214) and the frequency control unit (216). Additionally, the control unit (202) controls so as to display the operating status of the sound source processing unit (210) through the display unit (206).

The acoustic pressure generating unit (250) is provided as a handle (240) type and includes a vibration device (100) inside. The acoustic pressure generating unit (250) receives the sound wave signal from the output unit (218) of the sound source processing unit (210) and generates vibrations in response to the acoustic pressure variations of the sound wave signal using the vibration device (100). This acoustic pressure generating unit (250) transmits vibrations based on pressure applied through direct contact with specific parts of the human body by the mounted vibration probe (190, 260-266) while holding the handle (240). At this time, one of the various vibration probes (190, 260-266) is selected and coupled to the acoustic pressure generating unit (250).

The vibration probe (190) is coupled to the vibration device (100) of the acoustic pressure generating unit (250) and transmits the vibrations to the vibration stimulation unit (260-266).

The vibration stimulation unit (260-266) is provided in various forms to allow the human body stimulation device (200) to massage or stimulate the human body for various uses. The vibration stimulation unit (260-266), like the vibration probe (190), is mounted on or detached from the vibration device (100) of the acoustic pressure generating unit (250). The vibration stimulation unit (260-266) is provided in various forms depending on the massage area, stimulation area, or usage purpose on the human body; and one of them is selected and mounted on the acoustic pressure generating unit (250). The vibration stimulation unit (260-266) can be equipped, for example, with a sound wave transmission probe (260) for electrical stimulation, a vibration probe (262) for scalp massage, a vibration probe (264) for skin massage, a vibration probe (266) for hand and foot massage, and the like.

Additionally, the vibration stimulation unit (260-266) can be equipped as a detachable head on the vibration probe (190). A plurality of heads are equipped to be used for various uses. The heads can be equipped, for example, as a head for skin massage, a head for scalp massage, and a head for hand and foot massage. The heads can be made of various materials, such as silicone materials, wood materials, plastic materials, metal materials, and the like. Each of these heads is mounted on the vibration probe (190) to transmit the vibrations generated by the vibration device (100) to the human body to massage the skin, scalp, or hands and feet.

Therefore, the vibration probe (190) and the vibration stimulation units (260˜266) are each coupled to the connecting members (170, 170a) of FIG. 1 or FIG. 3, and receive vibrations from the congee damper (150) through the connecting member (170, 170a) to provide massage and stimulation to the human body.

Accordingly, the human body stimulation device (200) of the present invention stimulates the skin or scalp of the human body through various probes (190, 260-266) that receive vibrations from the congee damper (150) generating vibrations using the sound source.

### Bone Conduction Sound Generating Device

The bone conduction sound generating device (300) according to FIG. 6 of the attached drawings functions to generate bone conduction sound based on a light source so that the system according to the present invention can provide bone conduction sound to the human body through the transducer (400) along with the vibrations using acoustic pressure by the human body stimulation device (200) described above.

To this end, according to FIG. 6 of the attached drawings, the bone conduction sound generating device (300) comprises: a laser diode (310) providing a light source with a frequency of 100 kHz: an optical pulse transmitter (320) including a first pulse generator (321) generating pulses for frequency control of the light source and a second pulse generator (322) generating modulation pulses for pulse frequency modulation; and a laser driver (330) that amplitude modulates the frequency of the light source provided by the laser diode (310) to an audible frequency using the pulses of the optical pulse transmitter (320).

At this time, the frequency range of the amplitude-modulated signal can be 500 Hz, 1 kHz, 2 kHz, 5 kHz, and 10 kHz.

The laser driver (330) transmits the amplitude-modulated audible frequency to the transducer (400) so that the audible frequency is delivered as bone conduction sound to the wearer's body.

As described above, the configuration and operation of the vibration device and the human body stimulation device including the same according to the present invention have been illustrated based on the detailed description and the drawings, but these are merely examples, and various changes and modifications can be made without departing from the technical spirit of the present invention.

1. A human body stimulation system providing vibrations using acoustic pressure and bone conduction sound using photoacoustic sound, characterized by increasing the vibration intension of the vibration probe, wherein
the human body stimulation system comprises: a human body stimulation device (200) providing vibrations using acoustic pressure to the human body through a vibration device (100); and a bone conduction sound generating device (300) providing bone conduction sound using photoacoustic sound through a transducer (400), wherein
the human body stimulation system provides vibrations using acoustic pressure and bone conduction sound using photoacoustic sound, which can enhance the effects of human body stimulation by simultaneously providing vibrations and bone conduction sound to the human body, wherein
the bone conduction sound generating device (300) comprises:
a laser diode:
an optical pulse transmitter unit that includes a first pulse generator generating pulses for frequency control of the light source and a second pulse generator generating modulation pulses for pulse frequency modulation; and
a laser driver that amplitude modulates the frequency of the light source provided from the above laser diode into an audible frequency using the pulses from and optical pulse transmitter; wherein
the amplitude-modulated audible frequency through the laser driver is transmitted as bone conduction sound to the human body through the transducer, thereby providing tactile vibrations and auditory bone conduction sound to the brain simultaneously, and wherein
the vibration device (100) comprises:
a lower body with an open top forming a receiving space inside; a lower bracket with an open top and bottom installed in the receiving space of the lower body: a magnetic body fixedly installed in place on the lower surface of the lower body to generate magnetic force: a bobbin installed inside the lower bracket above the magnetic body: a voice coil installed on the outer circumferential surface of the bobbin to interact with the magnetic body: a congee damper installed on the upper surface of the bobbin and coupled to the upper edge of the lower bracket, generating vertical vibrations through the interaction between the magnetic body and the voice coils: a connecting member with a lower end coupled to the center of the congee damper and the center of the upper surface of the bobbin, and an upper end coupled to a vibration probe for human body stimulation, transmitting vibrations generated from the congee damper to the vibration probe: an upper plate installed on the upper surface of the magnetic body to guide the magnetic force of the magnetic body to be concentrated on the voice coil: an upper body in which the connecting member is inserted to pass through the center of the upper surface, covering the open top of the lower body; and an upper bracket with an open bottom installed inside the upper body, coupled to the lower bracket, and having the connecting member inserted to pass through its upper surface: wherein
the congee damper comprises:
a congee plate provided in the shape of a plate, generating vertical vibrations; and a plurality of dampers extending radially along the edge of the congee plate in a curved strip shape with coupling holes for screw coupling at the ends: with the dampers being fixedly coupled in place to the edges between the upper and lower brackets, and wherein
the connecting member is equipped with
an upper part screw coupled to the shaft of the vibration probe and a lower part screw coupled to the center of the upper surface of the congee damper and the bobbin, wherein the vibration probe has a securing groove along the outer circumferential surface at a specific position of the shaft: the connecting member has a coupling groove formed at the upper part into which the shaft is inserted or removed, and an elastic securing pin mounted in place in the coupling groove, seating or detaching in the securing groove when the shaft is inserted or removed, wherein the lower part is screw coupled to the center of the upper surface of the congee damper and the bobbin, and includes an upward concave groove on one side where the bolt of the shaft is not formed, wherein a vibrating body is coupled to the groove by a connector in the groove, pivoting to increase the vibration intensity of the vibration probe.

2. The human body stimulation system providing vibrations using acoustic pressure and bone conduction sound using photoacoustic sound of claim 1, characterized wherein
the human body stimulation device (200) comprises:
a sound source processing unit generating sound waves from an internal or external sound source: an acoustic pressure generating unit having a vibration device generating vibrations based on acoustic pressure by receiving sound waves from the sound source processing unit; and a vibration stimulation unit having various types of vibration probes, wherein any one of the vibration probes is mounted on the acoustic pressure generating unit, receiving vibrations from the vibration device through the mounted vibration probe to stimulate the human body: wherein the vibration device comprises: a lower body with an open top forming a receiving space inside: a lower bracket with an open top and bottom installed in the receiving space of the lower body: a magnetic body installed in place on the lower surface of the lower body to generate magnetic force: a bobbin installed inside the lower bracket above the magnetic body: a voice coil installed on the outer circumferential surface of the bobbin to interact with the magnetic body: an upper plate installed on the upper surface of the magnetic body to guide the magnetic force of the magnetic body to be concentrated on the voice coil; and a congee damper installed on the upper surface of the bobbin and coupled to the upper edge of the lower bracket, generating vertical vibrations through the interaction between the magnetic body and the voice coils; and
a connecting member with a lower end coupled to the center of the congee damper and the center of the upper surface of the bobbin, and an upper end coupled to a vibration probe for human body stimulation, transmitting vibrations generated from the congee damper to the vibration probe: an upper bracket with an open bottom installed in the space inside the upper body, coupled to the lower bracket, and having the connecting member inserted to pass through its upper surface; and an upper body in which the connecting member is inserted to pass through the center of the upper surface, covering the open top of the lower body.

3. The human body stimulation system providing vibrations using acoustic pressure and bone conduction sound using photoacoustic sound of claim 2, characterized wherein
the connecting member is equipped with
the vibration probe detachably mounted on the upper part, and
the lower part screw coupled to the center of the congee damper and the center of the upper surface of the bobbin.

4. The human body stimulation system providing vibrations using acoustic pressure and bone conduction sound using photoacoustic sound of claim 2, characterized wherein
the sound source processing unit is equipped with
at least one interface device for receiving sound sources from at least one of a portable memory card storing sound sources, an external electronic device, or wireless communication capable of downloading sound sources.
